(19) United States
(12) Patent Application Publication
(10) Pub. No.: US 2019/0274023 A1
(43) Pub. Date: Sep. 5, 2019

(54) INFORMATION PROCESSING DEVICE AND METHOD FOR CONTROLLING INFORMATION PROCESSING DEVICE

(71) Applicant: SHARP KABUSHIKI KAISHA, Sakai City, Osaka (JP)

(72) Inventors: NAOKI SHIOBARA, Sakai City (JP); MASAFUMI UENO, Sakai City (JP); MASAAKI MORIYA, Sakai City (JP)

(73) Assignee: SHARP KABUSHIKI KAISHA, Sakai City, Osaka (JP)

(21) Appl. No.: 16/332,191

(22) PCT Filed: Apr. 7, 2017
(86) PCT No.: PCT/JP2017/014567

§ 371 Date: Mar. 11, 2019

(30) Foreign Application Priority Data
Sep. 13, 2016 (JP) 2016-178751

(51) Int. Cl. H04W 4/80; G06F 3/041; H04M 1/725

(52) U.S. Cl. CPC H04W 4/80; H04M 1/7253; G06F 3/0414; G06F 3/0412

(57) ABSTRACT

The present disclosure increases the degree of freedom for setting a function region. In an information processing device (1), a communicable region is divided to obtain a plurality of regions that include a function region and a non-function region, or include a plurality of types of function regions. The information processing device is provided with a processing deciding unit (23) that decides the content of transmission or reception processing of information between an NFC terminal (100) and an NFC antenna (13a) in accordance with which region includes the position of the NFC terminal detected by a touch panel (11).

### TECHNICAL FIELD

The present disclosure relates to an information processing device that is capable of communicating with an information communication terminal.

### BACKGROUND ART

PTL 1 describes an image display device that is capable of communicating with an external terminal device. The image display device acquires, by means of a short-range wireless communication unit, an image that is being displayed on a display panel of the external terminal device, and acquires the position, range, or direction of the image with respect to the image display device by means of a touch panel. The image is then displayed on a display panel of the image display device on the basis of the position, range, or direction of the image.

### CITATION LIST

### Patent Literature

PTL 1: Japanese Unexamined Patent Application Publication “Japanese Unexamined Patent Application Publication No. 2013-54542 (published on Mar. 21, 2013)”

### SUMMARY OF INVENTION

### Technical Problem

However, in the image display device described in PTL 1, only one type of processing is executed regardless of the position of the external terminal device with respect to the image display device. In other words, in the image display device described in PTL 1, the entire region on the display panel is a region for realizing one type of function, and therefore there is a problem in that there is a low degree of freedom for setting a region for realizing a function.

The present disclosure has been devised in consideration of the aforementioned problem, and an objective thereof is to realize an information processing device that is capable of increasing the degree of freedom for setting a region for realizing a prescribed function using short-range wireless communication.

### Solution to Problem

In order to solve the aforementioned problem, an information processing device according to one aspect of the present disclosure is provided with: an antenna that carries out short-range wireless communication with an information communication terminal; and a position sensor that detects a position of the information communication terminal, on a position detection surface superposed on the antenna, in which at least one of at least one communicable region, of the antenna, where communication with the information communication terminal is possible is divided into a plurality of regions, (1) the plurality of regions include a function region that is associated with a prescribed function, and a non-function region that is not associated with the prescribed function, or (2) the plurality of regions include a plurality of types of function regions that are associated with mutually different functions, and there is further provided a processing deciding unit that decides content of transmission or reception processing of information between the information communication terminal and the antenna in accordance with which region from among the plurality of regions includes the position of the information communication terminal detected by the position sensor.

In addition, in order to solve the aforementioned problem, a method for controlling an information processing device according to one aspect of the present disclosure is a method for controlling an information processing device provided with: an antenna that carries out short-range wireless communication with an information communication terminal; and a position sensor that detects a position of the information communication terminal, on a position detection surface superposed on the antenna, in which at least one of at least one communicable region, of the antenna, where communication with the information communication terminal is possible is divided into a plurality of regions, (1) the plurality of regions include a function region that is associated with a prescribed function, and a non-function region that is not associated with the prescribed function, or (2) the plurality of regions include a plurality of types of function regions that are associated with mutually different functions, and the method includes a processing deciding step in which content of transmission or reception processing of information between the information communication terminal and the antenna is decided in accordance with which region from among the plurality of regions includes the position of the information communication terminal detected by the position sensor.

### Advantageous Effects of Invention

By means of an information processing device according to one aspect of the present disclosure, it becomes possible to increase the degree of freedom for setting a region for realizing a prescribed function using short-range wireless communication.

### BRIEF DESCRIPTION OF DRAWINGS

FIG. 1 is a block diagram depicting the configuration of an information processing device of embodiment 1.

FIG. 2 is a drawing depicting the configuration of a display provided in the information processing device of embodiment 1.

FIG. 3 is a flowchart depicting the flow of processing executed in the information processing device of embodiment 1.

FIG. 4(a) is a drawing depicting an example of function regions in the display, FIG. 4(b) is a drawing depicting a state in which an NFC terminal is arranged in a function region from among the function regions depicted in FIG. 4(a), and FIG. 4(c) is a drawing depicting another example of function regions in the display.

FIG. 5 is a block diagram depicting the configuration of an information processing device of embodiment 2.

FIG. 6 is a drawing depicting a camera, a projector, and a communication unit provided in the information processing device of embodiment 2.

FIG. 7(a) is a drawing depicting an overview of an example of a display of embodiment 3, and FIG. 7(b) is a drawing depicting an example of function regions that are set in the display depicted in FIG. 7(a).

FIGS. 8(a) to (c) are drawings depicting mutually different setting examples for function regions.

### DESCRIPTION OF EMBODIMENTS

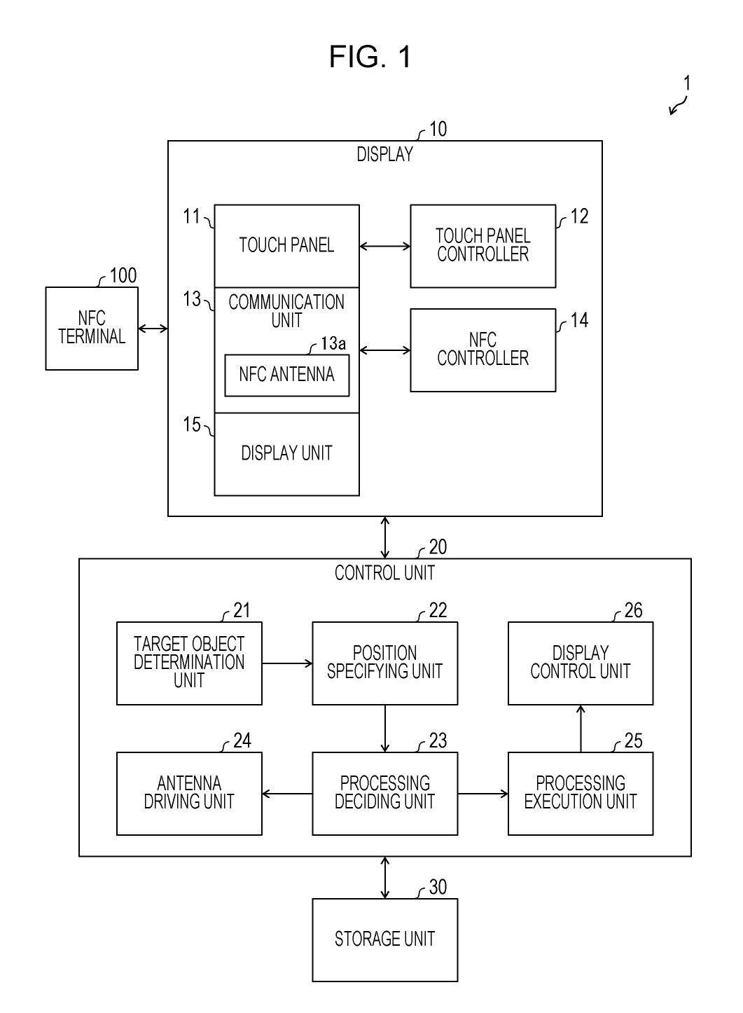

In the embodiments hereinafter, an example of data processing using short-range wireless communication will be described based on FIGS. 1 to 8.

It should be noted that short-range wireless communication represents general wireless communication in which the reach distance is short. Short-range wireless communication includes communication using RFID (radio frequency identification) technology, such as a non-contact IC (integrated circuit) card or a non-contact IC tag, for example in the present embodiment, unless explicitly described, in a case where simply the wording “communication” used, this may be understood as meaning short-range wireless communication. In the embodiments hereinafter, descriptions are given with NFC (near field communication) as an example of short-range wireless communication.

### Embodiment 1

Hereinafter, an embodiment of the present disclosure will be described using FIGS. 1 to 4.

FIG. 1 is a block diagram depicting the configuration of an information processing device 1 of the present embodiment. As depicted in FIG. 1, the information processing device 1 is provided with a display 10, a control unit 20, and a storage unit 30.

### (Display 10)

The display 10 is provided with a touch panel 11, a touch panel controller 12, a communication unit 13, an NFC controller 14, and a display unit 15. The display 10 may be used as digital signage, for example. In the information processing device 1, the touch panel 11, the communication unit 13, and the display unit 15 are integrated as the display 10, and operate together with respective coordinates of images of the touch panel 11, a communicable region, and the display unit 15 being linked. The communicable region will be described later.

The display 10 is a display provided with a function for carrying out short-range wireless communication with an NFC terminal 100 (information communication terminal). The NFC terminal 100 of the present embodiment is an information terminal that is capable of executing at least one function that has been set in the information processing device 1, on the basis of terminal information stored in the terminal, by carrying out short-range wireless communication with the information processing device 1. Here, terminal information is an NFC terminal ID for identifying the NFC terminal 100, terminal data that is unique information retained by the NFC terminal 100, and the like. Furthermore, a user ID for identifying a user who uses the NFC terminal 100 may be included in the terminal information.

It should be noted that there is no particular restriction to the type of the NFC terminal 100 provided that it is possible to communicate with an NFC antenna 13a (antenna), which is described later. As an example, the NFC terminal 100 may be (i) an NFC card, (ii) a body to which an NFC tag is attached, or (iii) a mobile terminal having an NFC communication function (also referred to as an NFC mounted mobile terminal).

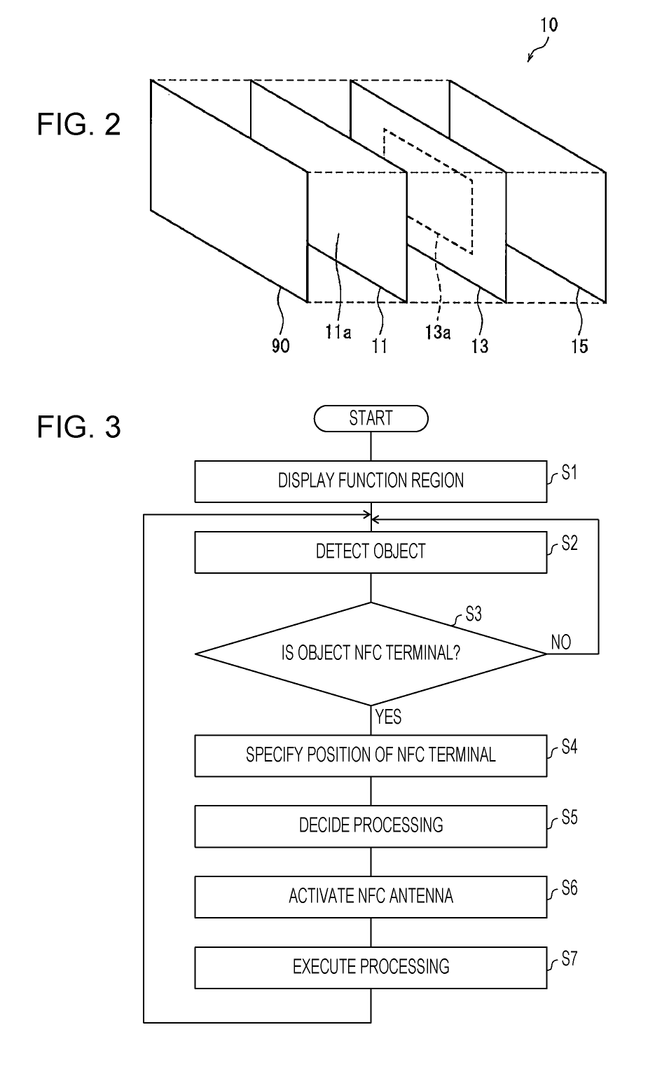

FIG. 2 is a drawing depicting the configuration of the display 10. The display 10 is configured with members being superposed in the order of, from the side where the user views images, protective glass 90, the touch panel 11, the communication unit 13, and the display unit 15. It should be noted that the touch panel controller 12 and the NFC controller 14 are omitted in FIG. 2.

The touch panel 11 is a position sensor that has a function for detecting the approach of an object and the position thereof. The touch panel 11 has a position detection surface 11a that is superposed on the NFC antenna 13a described later. The touch panel 11 detects the position of the NFC terminal 100 on the position detection surface 11a. Furthermore, the touch panel 11 also functions as an input device for the user to perform an input operation with respect to the information processing device 1 by means of his or her finger or the like. The surface of the touch panel 11 that faces the user is protected by the protective glass 90.

The touch panel 11 of the present embodiment is a capacitive touch panel. It should be noted that the touch panel 11 may detect the contact of an object on the position detection surface 11a. In other words, the position detection surface 11a is a surface that serves as a basis for a position sensor to detect the approach or contact of an object. Furthermore, instead of the capacitive touch panel 11, another type of sensor that is capable of detecting the contact or approach of an object and the position thereof may be used as a position sensor, such as an infrared sensor, a pressure sensor, or an illuminance sensor.

The touch panel controller 12 integrally controls the operation of the touch panel 11. Specifically, the touch panel controller 12 specifies a position on the touch panel (in other words, a position on the position detection surface 11a) where an object (for example, the NFC terminal 100) has approached. The touch panel controller 12 then transmits position information indicating the position to the control unit 20, which is described later.

The communication unit 13 is a communication device for carrying out short-range wireless communication with the NFC terminal 100. The communication unit 13 is an antenna module provided with the NFC antenna 13a. The NFC antenna 13a is a transparent antenna having a function for detecting the NFC terminal 100 and carrying out short-range wireless communication with the NFC terminal 100. The communication unit 13 of the present embodiment is provided with a single NFC antenna 13a.

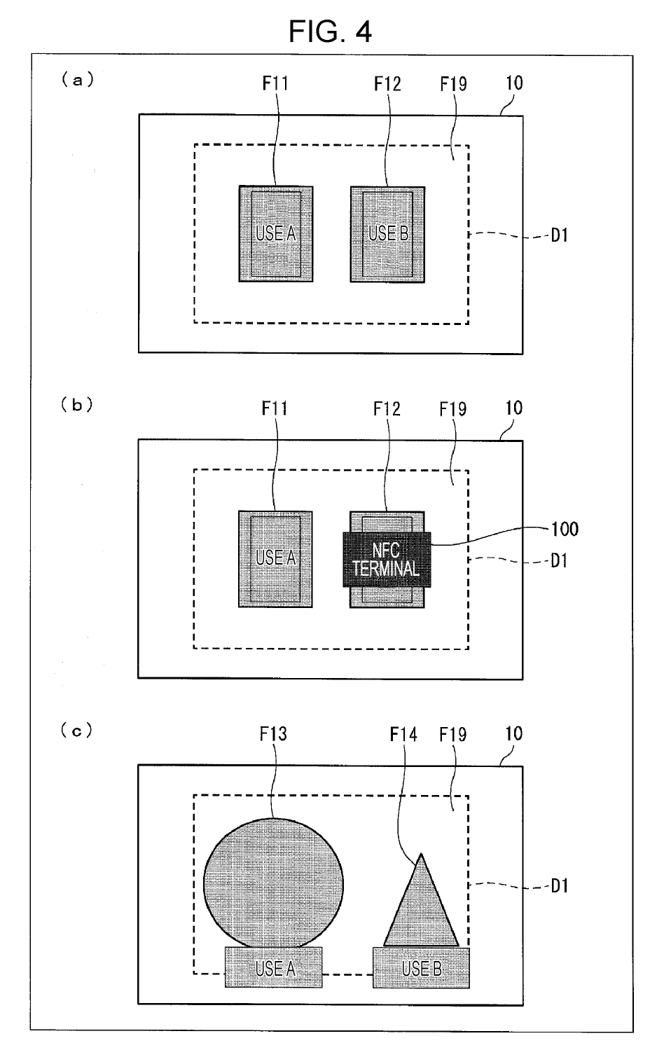

The NFC antenna 13a carries out short-range wireless communication with the NFC terminal 100. The NFC antenna 13a forms a communicable region in which communication with the NFC terminal 100 is possible. The communicable region is divided into a plurality of regions. Also, the plurality of regions include a function region that is associated with a prescribed function of the information processing device 1, and a non-function region that is not associated with the prescribed function. Furthermore, the plurality of regions obtained by dividing the communicable region may include a plurality of types of function regions associated with mutually different functions. In this case, the plurality of regions may not include a non-function region. A specific example of setting the plurality of regions and the function region and non-function region will be described later with reference to FIG. 4.

The NFC controller 14 is a member that controls the operation of the NFC antenna 13a. The NFC controller 14 controls the driving of the NFC antenna 13a on the basis of a control signal from the control unit 20 described later. Furthermore, the NFC controller 14 is able to carry out transmission or reception processing of information between the NFC antenna 13a and the NFC terminal 100 when the NFC antenna 13a is being driven.

The display unit 15 is a display device that displays images. The display unit 15 displays images depicting function regions, which are described later, superposed on the position detection surface 11a. The display unit 15 is an LCD (liquid crystal display), for example, but there is no restriction thereto. Furthermore, the display unit 15 may include a backlight.

### (Control Unit 20)

The control unit 20 integrally controls each unit of the information processing device 1. The control unit 20 is provided with a target object determination unit 21, a position specifying unit 22, a processing deciding unit 23, an antenna driving unit 24, a processing execution unit 25, and a display control unit 26.

The target object determination unit 21 determines whether or not an object (target object) that has come into contact with or approached the position detection surface 11a of the touch panel 11 is the NFC terminal 100. As mentioned above, the touch panel 11 of the present embodiment is capacitive. Therefore, in a case where an object that has come into contact or approached is the NFC terminal 100, the touch panel 11 detects a coil section of the NFC terminal 100, and is thereby able to detect the object in a wide range compared to a case where the object that has come into contact or approached is a finger. Consequently, the target object determination unit 21 is able to determine whether or not a detected object is the NFC terminal 100 from the size, shape, and the like of the object.

It should be noted that the target object determination unit 21 is able to determine whether or not a detected object is the NFC terminal 100 from the size, shape, and the like of the object even in a case where the aforementioned other sensors are used instead of the touch panel 11.

The position specifying unit 22 specifies the position of the NFC terminal 100 in a case where it has been determined by the target object determination unit 21 that the object is the NFC terminal 100. Generally, the object has a fixed size, and therefore the touch panel 11 detects the NFC terminal 100 across a fixed range. The position specifying unit 22 may specify any point decided on the basis of the range in which the NFC terminal 100 has been detected, for example, as the position of the NFC terminal 100. As a specific example, the position specifying unit 22 may specify the center of the range in which the NFC terminal 100 has been detected, as the position of the NFC terminal 100. Furthermore, for example, the position specifying unit 22 may specify the entire range in which the NFC terminal 100 has been detected, as the position of the NFC terminal 100.

The processing deciding unit 23 decides the content of the transmission or reception processing of information between the NFC terminal 100 and the NFC antenna 13a in accordance with which region from among the plurality of regions included in the communicable region of the NFC antenna 13a includes the position of the NFC terminal 100 specified by the position specifying unit 22. Specifically, in a case where a function region has been set in a region that includes the position of the NFC terminal 100, the processing deciding unit 23 decides the content of the transmission or reception processing of information, included in processing that realizes the prescribed function associated with the function region. Furthermore, in a case where a prescribed function is not associated with the region that includes the position of the NFC terminal 100, in other words, in a case where a non-function region has been set, since there is no function to be executed, the processing deciding unit 23 decides that the transmission or reception processing is not to be carried out, as the content of the transmission or reception processing.

It should be noted that, in a case where the position specifying unit 22 has specified the position of the NFC terminal 100 in a range, it is also feasible for two or more regions to include the position of the NFC terminal 100, from among the plurality of regions included in the communicable region of the NFC antenna 13a. In this case, for example, the processing deciding unit 23 may decide the content of the transmission or reception processing of information between the NEC terminal 100 and the NFC antenna 13a, with the region that includes the widest range from within the range of the NFC terminal 100, as a region that includes the position of the NFC terminal 100. Furthermore, in a case where a non-function region is included in two or more regions that include the position of the NFC terminal 100, the content of the processing may be decided based on only the range of the NFC terminal 100 included in a function region, with the range of the NFC terminal 100 included in the non-function region being ignored.

The antenna driving unit 24 causes the driving of the NFC antenna 13a to start after processing has been decided by the processing deciding unit 23. Furthermore, it is preferable for the antenna driving unit 24 to cause the driving of the NFC antenna 13a to stop when processing by the processing execution unit 25 has ended. It should be noted that the antenna driving unit 24 may cause the driving of the NFC antenna 13a to start when it has beer determined that the object is the NFC terminal 100 by the target object determination unit 21, before processing has been decided by the processing deciding unit 23.

In a case where a function region has been set in a region that includes the position of the NFC terminal 100, the processing execution unit 25 realizes a prescribed function that includes the content of the transmission or reception processing of information decided by the processing deciding unit 23.

For example, in a case where a prescribed function corresponding to a function region over which the NFC terminal 100 has been held is to be executed, the processing execution unit 25 transmits a transmission request for information (for example, the terminal ID) required to realize the function, to the NFC terminal 100 by controlling the NFC controller 14. When the NFC terminal 100 transmits information corresponding to the transmission request to the information processing device 1, the processing execution unit 25 receives the information via the NFC controller 14, and executes processing that corresponds to that information. At such time, in relation to executing the prescribed function, the processing deciding unit 23 decides that the transmission request is to be transmitted, as content of the transmission processing, and decides that information corresponding to the transmission request is to be received, as content of the reception processing.

Furthermore, other specific examples are given hereinafter. In one example, a function for transmitting a URL (uniform resource locator) to the NFC terminal 100 is allocated as a function of a function region, and a function for transmitting mutually different URLs to the NFC terminal 100 is allocated to a plurality of function regions. The processing deciding unit 23 decides that a URL associated with a function region including a position over which the NFC terminal 100 has been held is to be transmitted, as the content of the transmission processing. The processing execution unit 25 then transmits the URL decided by the processing deciding unit 23 to the NFC terminal 100.

Furthermore, in another example, a function for paying for a product is allocated as a function of a function region, and functions for paying for mutually different products are allocated to a plurality of function regions. The processing deciding unit 23 decides that payment content for a product associated with a function region including a position aver which the NFC terminal 100 has been held is to be transmitted, as the content of the transmission processing. The processing execution unit 25 then transmits the payment content decided by the processing deciding unit 23 to the NFC terminal 100.

Furthermore, in yet another example, in a case where the information processing device 1 provides a card game, a function relating to the appearance of a character is allocated as a function of a function region, and functions relating to the appearance of mutually different characters are allocated to a plurality of function regions. The processing deciding unit 23 decides that the result of processing relating to the appearance of a character (for example, the history of the character having been operated (played)) associated with a function region including a position over which the NFC terminal 100 has been held is to be transmitted, as the content of the transmission processing. The processing execution unit 25 transmits the result of the processing decided by the processing deciding unit 23 to the NFC terminal 100.

It should be noted that URL acquisition processing, payment processing, and a card game may be associated with each prescribed function. In addition, for example, unlocking processing may be allocated to a prescribed function.

As mentioned above, for example, the NFC terminal 100 is used for the acquisition of various types of information, for the authentication of people, objects, or the like, or for payments. Consequently, such information acquisition, authentication, or payment processing can be given as examples of the prescribed function, and transmission or reception processing for various information required to realize such processing can be given as an example of the aforementioned transmission or reception processing. Also, the processing content is different depending on the position (function region) over which the NFC terminal 100 is held.

Furthermore, processing that is the same but has mutually different content may be associated with each prescribed function. For example, even in a case where authentication processing is associated with each prescribed function, the content of that authentication processing may be mutually different. Here, for example, in a case where the information processing device 1 is to realize certain authentication processing, one of the items of processing decided by the processing deciding unit 23 is reception processing for a terminal ID. Furthermore, in a case where the information processing device 1 is to realize other authentication processing, one of the items of processing decided by the processing deciding unit 23 is reception processing for a terminal ID and prescribed information encrypted by the NFC terminal 100.

The display control unit 26 controls the display unit 15. Specifically, for example, the display control unit 26 causes the display unit 15 to display an image depicting the result of processing performed by the processing execution unit 25. Furthermore, the display control unit 26 causes the display unit 15 to display an image depicting a function region in at least one of the plurality of divided regions, and thereby causes the user to recognize that communication is possible within the range of the function region. Specifically, the display control unit 26 may cause the display unit 15 to display, across the entirety thereof, a single image that includes an image depicting a function region. Furthermore, the display control unit 26 may cause an image depicting a function region to be displayed in a region corresponding to a set function region in the display unit 15.

It should be noted that, in a case where an object determined as being the NFC terminal 100 by the target object determination unit 21 is actually not the NFC terminal 100, the transmission or reception processing (communication processing) of information performed by the processing execution unit 25 fails. In this case, the processing execution unit 25 may notify the target object determination unit 21 that the communication processing has failed. In this case, the target object determination unit 21 having received the notification may store, in the storage unit 30, data indicating the size and shape of the object having failed in the communication processing despite having been determined as being the NFC terminal 100. In addition, in a case where an object having the same size and shape has been detected by the touch panel 11 the next time or thereafter, the target object determination unit 21 may determine that the object is not the NFC terminal 100.

However, there is also a possibility of the communication processing failing in a case where communication is unstable, a case where the NFC terminal 100 has moved outside the communicable region between the detection on the touch panel 11 and the communication processing carried out by the processing execution unit 25, or the like, even if the object is the NFC terminal 100. In consideration of such a possibility, the target object determination unit 21 may carry out a determination for an object for which communication processing has failed, a plurality of times until data of the object is stored in the storage unit 30 as an object that is not the NFC terminal 100. Alternatively, the target object determination unit 21 may track the position of the object by means of the touch panel 11, between the detection of the object by the touch panel 11 and the execution of communication processing by the processing execution unit 25. It is thereby possible to improve the accuracy of a determination indicating that the object is not the NFC terminal 100, produced by the target object determination unit 21.

### (Storage Unit 30)

The storage unit 30 stores various types of data used by the display 10 and the control unit 20. For example, the storage unit 30 stores programs for functions to be executed by the processing execution unit 25. Furthermore, the storage unit 30 stores the range of the communicable region of the NFC antenna 13a, and the ranges of each of the plurality of regions obtained by dividing the communicable region, as coordinate data. Furthermore, the storage unit 30 stores data indicating associations between each region and a function region or non-function region, and data indicating the association between function regions and prescribed functions. Furthermore, the storage unit 30 stores image data indicating function regions, displayed on the display unit 15.

### (Processing Flow)

FIG. 3 is a flowchart depicting the flow of processing executed in the information processing device 1. The flow of processing (control method) executed in the information processing device 1 will be described with reference to FIG. 3. It should be noted that, in the information processing device 1, when processing is started, the touch panel 11 and the display unit 15 enter an activated state, and the NFC antenna 13a enters a standby state (state in which driving has stopped). When processing starts, first, the display control unit 26 causes the display unit 15 to display an image depicting a function region (S1). In this state, the control unit 20 waits until the touch panel 11 detects an object.

When the touch panel 11 detects an object (32), a signal generated by the touch panel 11 due to the object is transmitted from the touch panel controller 12 to the target object determination unit 21. The target object determination unit 21 determines whether or not the object is the NFC terminal 100 (S3). In a case where the object is not the NFC terminal 100 (no in S3), the control unit 20 waits until the touch panel 11 detects the object once again. However, in a case where it has been determined by the target object determination unit 21 that the object is the NFC terminal 100 (yes in S3), the target object determination unit 21 transmits the determination result to the position specifying unit 22. The position specifying unit 22 specifies the position of the NFC terminal 100 (S4).

Data indicating the position of the NFC terminal 100 specified by the position specifying unit 22 is transmitted to the processing deciding unit 23. The processing deciding unit 23 decides the content of the transmission or reception processing of information between the NFC terminal 100 and the NFC antenna 13a in accordance with a prescribed function associated with the function region that includes the position (S5, processing deciding step). Thereafter, the processing deciding unit 23 transmits data indicating that the processing content has been decided, to the antenna driving unit 24. The antenna driving unit 24 having received the data causes the driving of the NFC antenna 13a to start via the NFC controller 14 (S6). In addition, the processing deciding unit 23 transmits the decided processing content to the processing execution unit 25. The processing execution unit 25 then executes processing corresponding to the prescribed function (S7).

In the processing in S7, first, the processing execution unit 25 attempts communication between the NFC terminal 100 and the NFC antenna 13a. However, as mentioned above, it is also feasible that the communication may fail. In a case where the communication has been successful, the processing execution unit 25 executes processing for realizing a function that is based on the communication result, after which the control unit 20 returns to a standby state. However, in a case where the communication has failed, the control unit 20 returns to a standby state without the processing execution unit 25 executing processing for realizing a function that is based on the communication result.

It should be noted that, in a case where the region that includes the position of the NFC terminal 100 specified by the position specifying unit 22 is a non-function region, the processing deciding unit 23 decides that the transmission or reception processing of information between the NFC terminal 100 and the NFC antenna 13a is not to be carried out. In this case, the control unit 20 waits until the touch panel 11 detects an object once again.

### (Example of Function Region)

FIG. 4(a) is a drawing depicting an example of function regions in the display 10 in the example depicted in FIG. 4(a), a communicable region D1 is formed in the region enclosed by a dashed line, by the NFC antenna 13a (see FIG. 1). The range of the communicable region D1 is stored in the storage unit 30 in advance.

In the example of FIG. 4(a), the communicable region D1 is divided into three regions of the two regions indicated by colored rectangles and the region other than these. The two regions indicated by colored rectangles within the communicable region D1 are set as function regions F11 and F12 that are associated with mutually different functions. Furthermore, the region other than the function regions F11 and F12 within the communicable region D1 is set as a non-function region F19.

In the display 10, images depicting the function regions F11 and F12 are displayed on the display unit 15. Furthermore, descriptions (“use A” and “use B”) regarding processing corresponding to the function regions F11 and F12 are displayed within regions corresponding to the function regions F11 and F12 in the images. For example, as mentioned above, functions for transmitting mutually different URLs to the NFC terminal 100 may be allocated to the uses A and B. Furthermore, functions for paying for mutually different products or functions relating to the appearance of mutually different characters may be allocated to the uses A and B.

FIG. 4(b) is a drawing depicting a state in which the NFC terminal 100 has been arranged in the function region F12 from among the function regions F11 and F12 depicted in FIG. 4(a). When selecting use B, for example, it is sufficient for the user to merely arrange the NFC terminal 100 in the function region F12 associated with use B, as depicted in FIG. 4(b).

Here, with regard to the position of the NFC terminal 100, the NFC antenna 13a is able to detect whether or not the NFC terminal 100 is present within the communicable region D1 but is not able to detect the specific position of the NFC terminal 100 in the communicable region D1. Therefore, with the single NFC antenna 13a, it is difficult for functions to be switched in accordance with the position of the NFC terminal 100.

Thus, as an example of a method for making it possible for the user to select a function to be executed by the information processing device in a case where the NFC terminal 100 has a plurality of functions, it is feasible for the information processing device to be provided with a plurality of NFC antennas that are associated with a plurality of mutually different types of functions. In this case, the NFC antenna with which communication has been carried out between the information processing device and the NFC terminal 100 is specified, and the function corresponding to the NFC antenna is executed by the information processing device. However, in this method, there is a problem in that there is an added cost for the information processing device in order to provide the plurality of NFC antennas. Furthermore, processing for specifying the NFC antenna with which communication has been carried out is required, and therefore there is also a problem in that there is an increase in the amount of processing for the information processing device.

Furthermore, in an information processing device having a single communicable region, after communication with the NFC terminal 100, it is also feasible that the function to be executed by the information processing device may be selected by another user by means of an input device. In addition, in an information processing device having a single function region, a method is also feasible in which the function corresponding to the function region is switched according to time, and communication is carried out at a timing corresponding to the desired function. However, in these methods, there is a problem in that the time and labor for the user increases because it is necessary for the user to carry out additional operations or to wait until a timing when the function region corresponds to the desired function.

In the information processing device 1 according to one aspect of the present disclosure, the communicable region D1 for the NFC antenna 13a is divided into a plurality of regions, and the function regions F11 and F12 are set according to the regions. Therefore, an increase in cost is suppressed compared to a case where a number of NFC antennas 13a corresponding to the functions are provided, and processing for specifying the NFC antenna 13a that has communicated with the NFC terminal 100 is also not required. In addition, it is sufficient for the user to merely arrange the NFC terminal 100 in the function region F11 or F12 corresponding to the desired function, and therefore there is no time and labor for selecting another function. In addition, the function regions F11 and F12 can be set arbitrarily within the communicable region D1, and therefore the degree of freedom for setting the function regions F11 and F12 is improved.

Furthermore, even in a case where a plurality of NFC antennas 13a are provided as described in embodiment 3, by dividing the communicable region into a plurality of regions for at least one NFC antenna 13a in such a way that the plurality of regions include a function region and a non-function region, or a plurality of function regions, the degree of freedom for setting function regions is improved.

FIG. 4(c) is a drawing depicting another example of function regions in the display 10. In the example depicted in FIG. 4(c), a circular function region F13 and a triangular function region F14 are set within the communicable region D1. Furthermore, the region other than the function regions F13 and F14 within the communicable region D1 is set as the non-function region F19.

The size, shape, quantity, and so forth of the function regions may be freely set provided that the function regions are within the communicable region. For example, as depicted in FIG. 4(c), the shapes of the function regions F13 and F14 may be circular, triangular, or yet another shape. Furthermore, in the images depicting the function regions F13 and F14, a description of the processing corresponding to the function regions F13 and F14 may be arranged outside the regions corresponding to the function regions F13 and F14 rather than inside the regions corresponding to the function regions F13 and F14.

Furthermore, the plurality of regions obtained by dividing the communicable region may include only a plurality of function regions associated with a plurality of mutually different types of function regions, without including a non-function region. Furthermore, function regions of the same type may be formed in a plurality of places.

It should be noted that, in FIGS. 4(a) to (c), to aid the description, the communicable region D1 is depicted using a dashed line. However, an image depicting the communicable region D1 may not be displayed on the display unit 15.

Furthermore, the function regions may be ordinarily fixed, or may be altered depending on a prescribed condition. In the case of the latter, for example, the processing deciding unit 23 may vary the shape of the function regions, the functions associated with the function regions, or the like in accordance with a time duration. In this case, it is preferable for the display control unit 26 to cause the display unit 15 to display images corresponding to a function region for each period of time.

Furthermore, when a conventional information processing device displays a communicable region, there are cases where the entire communication function region is not displayed accurately. For example, there are cases where only a partial region within the communicable region is displayed as the communicable region. In this case, a deviation has occurred between the actual communicable region and the displayed communicable region, and therefore, in the region (deviation region) that is within the actual communicable region but is different from the displayed communicable region, communication that is not intended by the user may be carried out due to the user unintentionally holding an NFC terminal thereover, for example.

According to the information processing device 1 according to one aspect of the present disclosure, as mentioned above, the function regions F11 and F12 are set to a plurality of regions obtained by dividing the communicable region D1. Then, in a case where images depicting the set function regions F11 and F12 are displayed on the display unit 15, the functions associated with the function regions can be executed if the user holds the NFC terminal 100 over those function regions F11 and F12. Therefore, there is never a time when unintended communication such as the aforementioned is carried out.

### <Effects>

In the information processing device 1, the processing deciding unit 23 decides the content of the transmission or reception processing of information between the NFC terminal 100 and the NFC antenna 13a in accordance with which of the function regions F11 and F12 and the non-function region F19 that have been set in the communicable region D1 of the NFC antenna 13a includes the position of the NFC terminal 100 detected by the touch panel 11. Therefore, the information processing device 1 is able to decide the content of the transmission or reception processing in accordance with the relationship between the position of the NFC terminal 100 and the position of the function region F11, the function region F12, or the non-function region F19. Consequently, according to the information processing device 1, it is possible to increase the degree of freedom for setting the function regions F11 and F12.

Furthermore, according to the information processing device 1, the user is able to cause a desired function to be executed by merely arranging the NFC terminal 100 so as to be included in the function region associated with that function, from among the function region F11 or F12. Consequently, the user is easily able to cause the information processing device 1 to execute various functions.

Furthermore, according to the information processing device 1, the target object determination unit 21 determines whether a body detected by the touch panel 11 is the NFC terminal 100. The processing deciding unit 23 then decides the content of the aforementioned processing only in a case where it has been determined that the object is the NFC terminal 100. Consequently, the amount of processing in the information processing device 1 is reduced compared to a case where the determination by the target object determination unit 21 is not carried out (in other words, the decision performed by the processing deciding unit 23 is carried out even for objects that are not the NFC terminal 100).

Furthermore, in the information processing device 1, images depicting the function regions F11 and F12 are displayed by the display unit 15 superposed on the touch panel 11. Consequently, the user is able to visually perceive the function regions F11 and F12, and therefore easily position the NFC terminal 100 in the desired function region.

### Modified Examples

The aforementioned information processing device 1 is a device that executes communication by means of NFC with the NFC terminal 100. However, the information processing device 1 according to one aspect of the present disclosure may be a device that carries out communication with an information communication terminal other than the NFC terminal 100 by means of a communication scheme other than NFC.

Furthermore, the aforementioned information processing device 1 is provided with the display unit 15 that displays the function regions F11 and F12. However, the information processing device 1 of the present embodiment does not need to be provided with the display unit 15 in a case where the user comprehends the function regions F11 and F12 and is able to use the information processing device 1 without the function regions F11 and F12 being displayed. Furthermore, in a case where it is not necessary at all for the function regions F11 and F12 to be altered, and it is not necessary to display as image depicting the result of processing by the processing execution unit 25, the display unit 15 may be a signboard or the like rather than a device that is capable of altering the displayed content such as an LCD. In these cases, it is not necessary for the control unit 20 to be provided with the display control unit 26.

Furthermore, in the aforementioned information processing device 1, the antenna driving unit 24 causes the driving of the NFC antenna 13a to stop when not in the period from the processing decision carried out by the processing deciding unit 23 to the completion of the processing carried out by the processing execution unit 25. However, the antenna driving unit 24 may cause the NFC antenna 13a to be driven in such a way that it is possible to detect only whether or not the NFC terminal 100 is present near the NFC antenna 13a, without the driving of the NFC antenna 13a being stopped. Information indicating whether or not the NFC terminal 100 is present near the NFC antenna 13a is transmitted from the NFC controller 14 to the control unit 20.

In this case, the target object determination unit 21 is able to determine whether or not an object detected by the touch panel 11 is the NFC terminal 100 using the aforementioned information, in addition to the size and shape of the object. Consequently, it is possible to improve the accuracy of the determination made by the target object determination unit 21, or to shorten the time required for the determination.

Furthermore, in the case of an information processing device that is provided with a plurality of NFC antennas 13a as in embodiment 3 described later, it is also possible to assist the specifying of the position of the NFC terminal 100 by specifying the position of the NFC antenna 13a that has detected the NFC terminal 100.

Furthermore, in a case where detection is carried out regarding only whether or not the NFC terminal 100 is in contact with or approaching the position detection surface 11a, the power consumption of the NFC antenna 13a is low compared to a case where the NFC antenna 13a is driven in such a way as to be able to communicate with the NFC terminal 100. Consequently, also in this case, the power consumption of the information processing device 1 can be reduced compared to a case where the NFC antenna 13a is ordinarily driven in such a way that communicate is possible.

### Embodiment 2

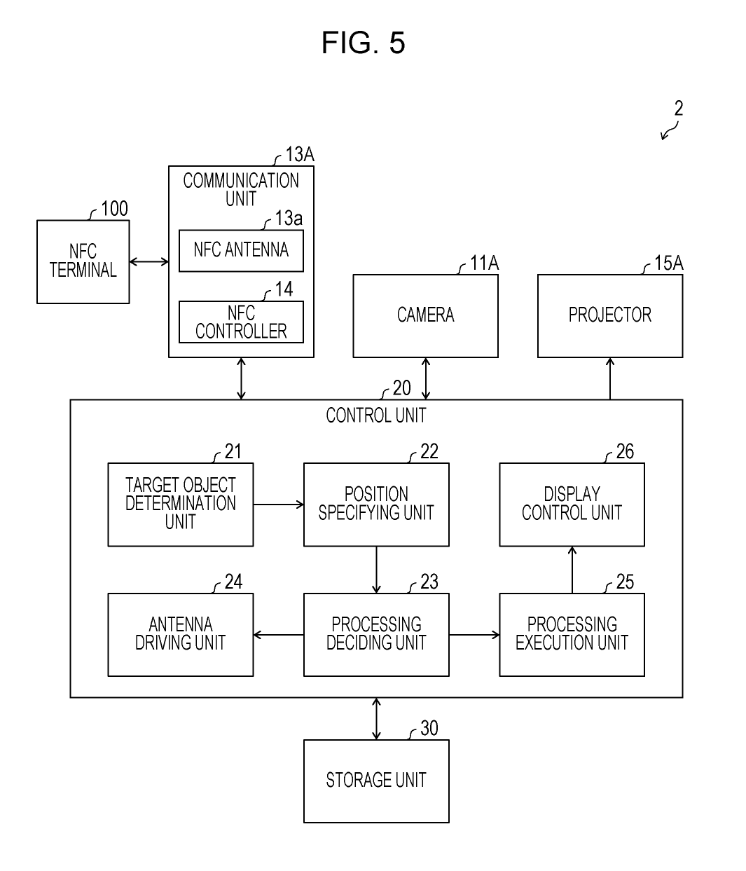

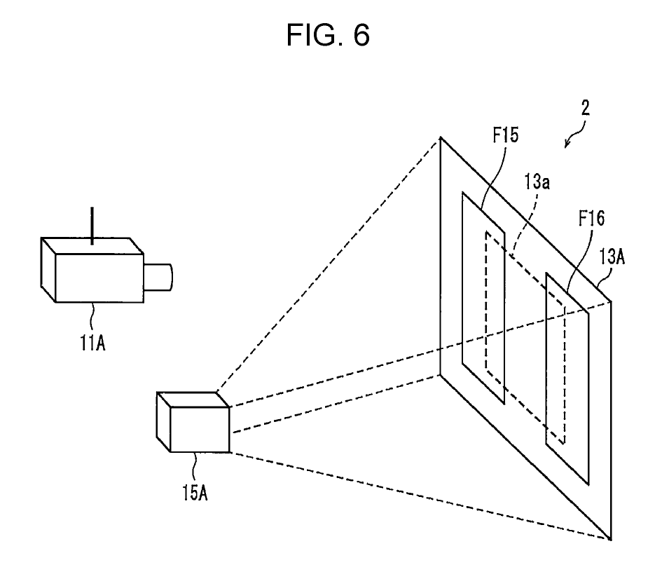

Another embodiment of the present disclosure is as follows when described on the basis of FIGS. 5 and 6. It should be noted that, for convenience of the description, members having the same functions as the members described. in the aforementioned embodiment are denoted by the same reference signs and descriptions thereof are omitted.

In the information processing device 1 described in embodiment 1, the touch panel 11, the communication unit 13, and the display unit 15 are integrated as the display 10, and operate together with respective coordinates of images of the touch panel 11, the communicable region D1, and the display unit 15 being linked. However, in an information processing device 2 according to one aspect of the present disclosure, it is not necessary for a position sensor (touch panel 11), the communication unit 13, and the display unit 15 to be a single body provided that it is possible for the coordinates to be linked.

FIG. 5 is a block diagram depicting the configuration of the information processing device 2 of the present embodiment. As depicted in FIG. 5, the information processing device 2 is different from the information processing device 1 in being provided with a camera 11A, a communication unit 13A, and a projector 15A instead of the display 10. The camera 11A, the communication unit 13A, and the projector 15A are not a single body and are separate from each other.

The projector 15A is a device that projects a prescribed image by means of control performed by the display control unit 26. The display control unit 26 reads the prescribed image from the storage unit 30 and transmits the prescribed image to the projector 15A, and the projector 15A thereby projects the image. An image depicting a function region is a possible example of the prescribed image. It should be noted that, in the information processing device 2 of the present embodiment, a surface on which the image is projected serves as a position detection surface.

The communication unit 13A is a communication module similar to the communication unit 13 in the information processing device 1. In the present embodiment, the surface of the communication unit 13A facing the projector 15A functions as a screen on which images are projected by the projector 15A. It should be noted that the information processing device 2 of the present embodiment may have a separate screen. In this case, the communication unit 13A is arranged superposing the screen. Furthermore, in this case, the surface of the screen on which images are projected by the projector 15A serves as a position detection surface.

The camera 11A is an imaging device that captures an image of a prescribed imaging region. The prescribed imaging region includes function regions that are set within the communicable region of the NFC antenna 13a at least. The camera 11A captures images of the imaging region at prescribed time intervals, for example, and transmits the images to the control unit 20. In the control unit 20, the target object determination unit 21 carries out image recognition processing, and thereby determines whether or not an image of the NFC terminal 100 is included in an image of the imaging region.

FIG. 6 is a drawing depicting the camera 11A, the projector 15A, and the communication unit 13A provided in the information processing device 2. The control unit 20 and the storage unit 30 are omitted in FIG. 6. In the example of FIG. 6, in the information processing device 2, images depicting function regions F15 and F16 are displayed on the surface of the communication unit 13A by the projector 15A. It should be noted that an image depicting the position of the NFC antenna 13a may not be displayed on the surface of the communication unit 13A. An image of the imaging region including the communication unit 13A is then captured by the camera 11A.

On the basis of an image of an object, the target object determination unit 21 carries out image recognition processing and thereby determines whether or not the object is the NTC terminal 100. Furthermore, the position specifying unit 22 specifies the position of the NFC terminal 100 in accordance with the positions of pixels making up an image of the NFC terminal 100, included in the image of the imaging region. The processing deciding unit 23 then decides the content of the transmission or reception processing of information between the NFC terminal 100 and the NEC antenna 13a, on the basis of the position of the NFC terminal 100 specified by the position specifying unit 22.

This kind of information processing device 2 also demonstrates a similar effect to that of the information processing device 1.

### Embodiment 3

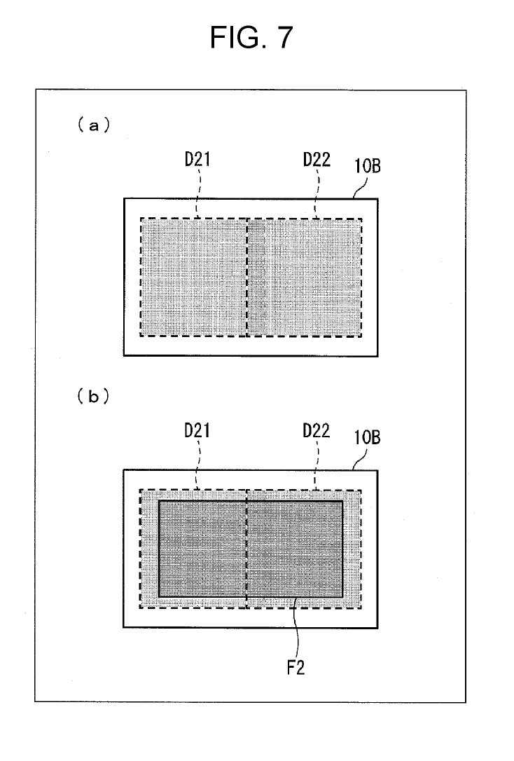

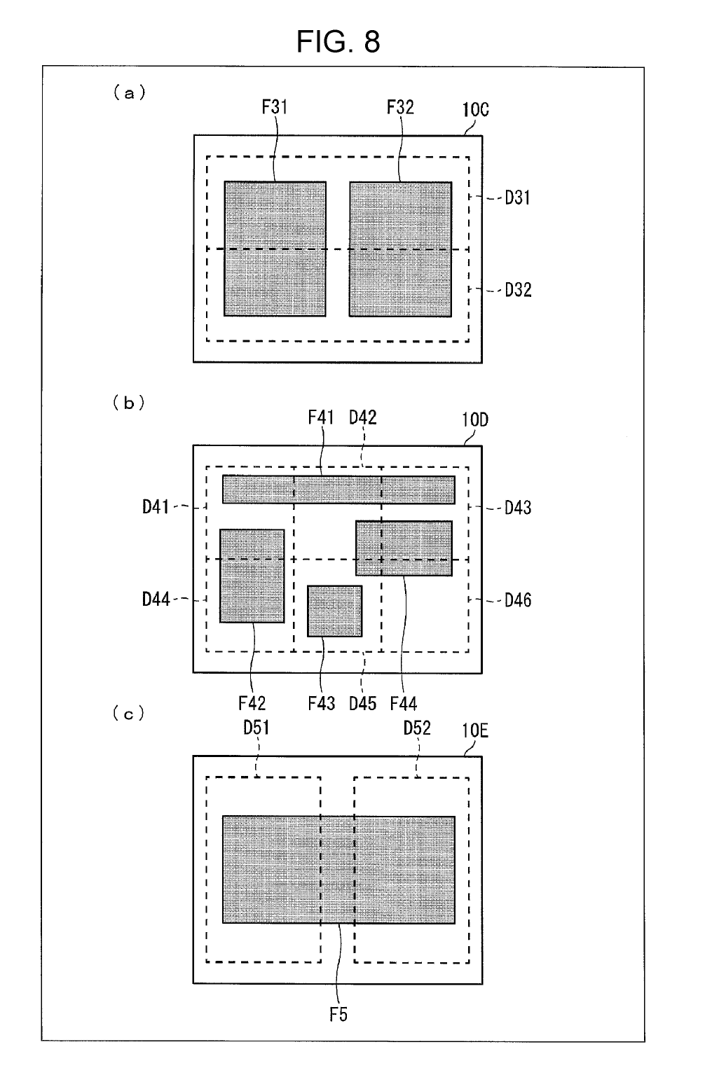

Another embodiment of the present disclosure will be described with reference to FIGS. 7 and 8.

Displays 10B to 10E of the present embodiment are provided with a plurality of NFC antennas 13a. Therefore, in the displays 10B to 10E, the output of one NFC antenna 13a can be suppressed compared to the display 10. Furthermore, at least one of the communicable regions formed by these NFC antennas 13a is divided into a plurality of regions, and the plurality of regions include a function region and a non-function region, or include a plurality of types of function regions associated with mutually different functions. It should be noted that only the displays 10B to 10E will be described here since the information processing device of the present embodiment has a similar configuration to that of the information processing device 1 other than being provided with a plurality of NFC antennas 13a.

FIG. 7(a) is a drawing depicting an overview of an example of the display 10B of the present embodiment. The display 10B is provided with two NFC antennas 13a (not depicted). In the display 10B, the two NFC antennas 13a are arranged so as to be adjacent. The NFC antennas 13a then respectively form communicable regions D21 and D22 depicted by dashed lines. The communicable regions D21 and D22 are partially superposed. Therefore, the communicable regions D21 and D22 are contiguous regions.

FIG. 7(b) is a drawing depicting an example of a function region F2 that is set in the display 10B. As depicted in FIG. 7(b), in the display 10B, the function region F2 is set so as to extend across the communicable regions D21 and D22. In other words, within the communicable regions D21 and D22, the location where the function region F2 is not set is a non-function region.

As mentioned above, the communicable regions D21 and D22 in the display 10B are partially superposed with each other. Therefore, even if the communicable region D21 or D22 changes to a certain extent due to the deterioration of an NFC antenna 13a or the like, a state is maintained in which the communicable regions D21 and D22 are contiguous.

Furthermore, even with the communicable regions D21 and D22, there is a possibility of the communication strength declining and communication becoming unstable at a position separated from the NFC antennas 13a. In the display 10B, by superposing the communicable regions D21 and D22 so that the communication becomes stable, it becomes possible to obtain a communication strength that is stable across the entirety of the communicable regions D21 and D22. In this case, it becomes possible for communication to be carried out in a position where the touch panel 11 detected the NFC terminal 100, using the NFC antenna 13a with which communication with the NFC terminal 100 is the most stable.

However, in the display 10B of the present embodiment, the communicable regions D21 and D22 do not necessarily have to be superposed, and, for example, the end sections of the communicable regions D21 and D22 may be in contact with each other.

It should be noted that a plurality of function regions corresponding to a plurality of types of functions may be set in the communicable regions D21 and D22. In this case, a non-function region may not be set in the communicable regions D21 and D22.

Furthermore, it is not necessary for both the communicable regions D21 and D22 to be divided into a plurality of regions. That is, it is sufficient for at least one of the communicable regions D21 and D22 to be divided into a plurality of regions, and for a function region and a non-function region, or a plurality of function regions, to be set.

Furthermore, the display 10B of the present embodiment may be provided with three or more NFC antennas 13a. In this case, it is preferable for the communicable regions of at least two adjacent NFC antennas 13a to superposed with each other.

FIG. 8(a) is a drawing depicting a setting example for function regions F31 and F32 in the display 10C, which is different from the display 10B. The display 10C is provided with two NFC antennas 13a (not depicted). In the display 10C, the two NFC antennas 13a are arranged so as to be adjacent. The NEC antennas 13a then respectively form communicable regions D31 and D32 depicted by dashed lines. The function regions F31 and F32 are then both set extending across the communicable regions D31 and D32.

FIG. 8(b) is a drawing depicting an example of function regions F41 to F44 in the display 10D, which is different from the display 10C. The display 10D is provided with six NFC antennas 13a (not depicted), and the six NFC antennas 13a are arranged so as to be adjacent. Communicable regions D41 to D46 depicted by dashed lines are then formed by the respective NFC antennas 13a. Function regions F41 to F44 are then set in the communicable regions D41 to D46.

Specifically, the function region F41 is set extending across part of each of the communicable regions D41 to D43. The function region F42 is set extending across part of each of the communicable regions D41 and D44. The function region F43 is set extending across part of the communicable region D45. The function region F44 is set extending across part of each of the communicable regions D42, D43, D45, and D46. That is, the plurality of function regions F41 to F44 may be set so that some extend across a plurality of communicable regions (two or more communication function regions from among D41 to D46), and some fall within a single communicable region (any communication function region of D41 to D46). Furthermore, one function region (any function region of F41 to F44) may extend across three or more communicable regions from among the plurality of communicable regions D41 to D46.

FIG. 8(c) is a drawing depicting an example of a function region F5 in the display 10E, which is different from the display 10D. The display 10E is provided with two NFC antennas 13a (not depicted), and the two NFC antennas 13a are arranged so as to be adjacent. Communicable regions D51 and D52 depicted by dashed lines are then formed by the respective NFC antennas 13a. The communicable regions D51 and D52 are separated from each other. Furthermore, the function region F5 is set extending across part of each of the communicable regions D51 and D52.

According to the use of the information processing device of the present embodiment, there are also cases where it is permitted for a region in which communication is not possible to be generated within a function region. In such cases, the function region F5 may be set extending across the communicable regions D51 and D52, which are separated from each other, and part of the function region F5 may be present outside the communicable regions D51 and D52, as depicted in FIG. 8(c).

Furthermore, similar to other examples, a plurality of function regions may be set extending across the communicable regions D51 and D52. In addition, the function region F5 extending across the communicable regions D51 and D52, and a function region that falls within only either one of the communicable regions D51 and D52 may be set.

It should be noted that, also in FIGS. 8(a) to (c), a plurality of types of function regions may be set in all of the communicable regions D31, D32, D41 to D46, D51, and D52, and a non-function region may not be set. Furthermore, it is sufficient for a function region and a non-function region, or a plurality of function regions, to be set with dividing being carried out into a plurality of regions in either of the communicable regions D31 and D32, at least one of the communicable regions D41 to D46, and either of the communicable regions D51 and D52. Furthermore, the quantity of the NFC antennas 13a is not restricted to the aforementioned example.

As mentioned above, according to one aspect of the present disclosure, the function regions F31, F32, F41 to F44, and F5 can be set extending across the communicable regions D31, D32, D41 to D46, D51, and D52 formed by a plurality of NFC antennas 13a.

It should be noted that, in a case where there are a plurality of NFC antennas 13a, the distances between the NFC antennas 13a are not all necessarily uniform. In this case, communicable regions are superposed between certain NFC antennas 13a, and regions that are not communicable regions are produced between other NFC antennas 13a. Consequently, the positions where communicable regions are formed can be adjusted as appropriate by the arrangement of the plurality of NFC antennas 13a.

### [Example of Implementation by Means of Software]

Control blocks for the information processing devices 1 and 2 (the control unit 20 in particular) may be realized by means of logic circuits (hardware) formed in an integrated circuit (IC chip) or the like, or may be realized by means of software using a CPU (central processing unit).

In the case of the latter, the information processing devices 1 and 2 are provided with a CPU that executes instructions of a program that is software for realizing each function, a ROM (read only memory) or a storage device (these are referred to as a “recording medium”) in which the program and various types of data are recorded in a computer (or CPU) readable manner, a RAM (random access memory) that deploys the program, and so forth. The objective of one aspect of the present disclosure is then achieved by the computer (or the CPU) reading the program from the recording medium and executing the program. As the recording medium, it is possible to use a “non-transitory tangible medium”; for example, tape, a disk, a card, a semiconductor memory, a programmable logic circuit, or the like. Furthermore, the program may be provided to the computer via an arbitrary transmission medium (a communication network, broadcast waves, or the like) that is capable of transmitting the program. It should be noted that one aspect of the present disclosure can also be realized in the form of a data signal that is embedded in carrier waves, in which the program is realized by means of an electronic transmission.

### [Summary]

An information processing device (1, 2) according to aspect 1 of the present disclosure is provided with an antenna (NFC antenna 13a) that carries out short-range wireless communication with an information communication terminal (NFC terminal 100); and a position sensor (touch panel 11 or the like) that detects a position of the information communication terminal, on a position detection surface (11a) superposed on the antenna, in which at least one of at least one communicable region (D1 or the like), of the antenna, where communication with the information communication terminal is possible is divided into a plurality of regions, (1) the plurality of regions include a function region (F11 or the like) that is associated with a prescribed function, and a non-function region (F19) that is not associated with the prescribed function, or (2) the plurality of regions include a plurality of types of function regions that are associated with mutually different functions, and there is further provided a processing deciding unit (23) that decides content of transmission or reception processing of information between the information communication terminal and the antenna in accordance with which region from among the plurality of regions includes the position of the information communication terminal detected by the position sensor.

According to the aforementioned configuration, regions obtained by dividing at least one communicable region of the antenna into a plurality include a function region and a non-function region, or include a plurality of types of function regions having mutually different functions. The information processing device then decides the content of transmission or reception processing of information between the information communication terminal and the antenna in accordance with which region of the aforementioned regions includes the position of the information communication terminal on the position detection surface. Therefore, the information processing device is able to decide the content of the transmission or reception processing in accordance with the relationship between the position of the information communication terminal and the position of the function region or the non-function region.

Consequently, according to the information processing device, it is possible to increase the degree of freedom for setting a region (namely a function region) for realizing a prescribed function using short-range wireless communication.

Furthermore, in the case of the configuration of the aforementioned (2), the content of the transmission or reception processing is decided in accordance with which function region from among the plurality of types of function regions includes the position of the information communication terminal. The plurality of types of function regions are associated with mutually different functions, and therefore the user is able to cause a desired function to be executed by merely arranging the information communication terminal so as to be included in the function region associated with that function. Consequently, the user is easily able to cause the information processing device to execute various functions.

For an information processing device according to aspect 2 of the present disclosure, in the aforementioned aspect 1, it is preferable for there to be further provided a target object determination unit (21) that determines whether or not a target object that has come into contact with or approached the position detection surface is the information communication terminal, and for the processing deciding unit, in a case where the target object determination unit has determined that the target object is the information communication terminal, to decide the content of the transmission or reception processing.

According to the aforementioned configuration, it is possible for decision processing for the transmission or reception processing carried out by the processing deciding unit to be executed only in a case where a target object detected by the position sensor is the information communication terminal. Consequently, it is possible to reduce the amount of processing in the information processing device.

For an information processing device according to aspect 3 of the present disclosure, in the aforementioned aspect 1 or 2, it is preferable for the position sensor to be a touch panel (11) that has the position detection surface.

According to the aforementioned configuration, a target object that has come into contact with or approached the position detection surface can be detected by the touch. panel.

For an information processing device according to aspect 4 of the present disclosure, in any of the aforementioned aspects 1 to 3, it is preferable for there to be further provided a display unit (15) that is superposed on the position detection surface and displays the function region in at least one of the regions.

According to the aforementioned configuration, function regions can be displayed by the display unit to a user of the information processing device. Consequently, the user is able to visually perceive the function regions, and therefore easily position the information communication terminal in the desired function region.

For an information processing device according to aspect 5 of the present disclosure, in any of the aforementioned aspects 1 to 4, it is preferable for the antenna to be provided is plurality.

According to the aforementioned configuration, due to a plurality of antennas being provided, it becomes possible for a communicable region to be formed across the entirety of a wider position detection surface.

In addition, a method for controlling an information. processing device (1, 2) according to aspect 6 of the present disclosure is a method for controlling an information processing device provided with: an antenna (13) that carries out short-range wireless communication with an information communication terminal (NFC terminal 100); and a position sensor (touch panel 11) that detects a position of the information communication terminal, on a position detection surface (11a) superposed on the antenna, in which at least one of at least one communicable region (D1), of the antenna, where communication with the information communication terminal is possible is divided into a plurality of regions, (1) the plurality of regions include a function region (F11 or the like) that is associated with a prescribed function, and a non-function region (F19) that is not associated with the prescribed function, or (2) the plurality of regions include a plurality of types of function regions that are associated with mutually different functions, and the method includes a processing deciding step in which content of transmission or reception processing of information between the information communication terminal and the antenna is decided in accordance with which region from among the plurality of regions includes the position of the information communication terminal detected by the position sensor.

According to the aforementioned configuration, a similar effect to that of aspect 1 is demonstrated.

The information processing device according to each aspect of the present disclosure may be realized by means of a computer, and, in this case, an information processing program for the information processing device that causes the computer to realize the information processing device by causing the computer to operate as the units (software elements) provided in the information processing device, and a computer-readable recording medium having the information processing program recorded thereon also fall within the category of one aspect of the present disclosure.

### [Supplementary Matters]

One aspect of the present disclosure is not restricted to the aforementioned embodiments, various alterations are possible within the scope indicated in the claims, and embodiments obtained by appropriately combining the technical means disclosed in each of the different embodiments are also included within the technical scope of one aspect of the present disclosure. In addition, novel technical features can be formed by combining the technical means disclosed in each of the embodiments.

### CROSS-REFERENCE TO RELATED APPLICATION

The present application claims the benefit of priority from Japanese Patent Application No. 2016-178751 filed on Sep. 13, 2016, the entire contents of which are included herein by reference thereto.

### REFERENCE SIGNS LIST

1, 2 Information processing device

11 Touch panel (position sensor)

11A Camera (position sensor)

13a NFC antenna (antenna)

15 Display unit

15A Projector (display unit)

21 Target object determination unit

23 Processing deciding unit

100 NFC terminal (information communication terminal)

D1, D21, D22, D31, D32, D41, D42, D43, D44, D45, D46, D51, D52 Communicable region

F11, F12, F13, F14, F15, F16, F2, F31, F32, F41, F42, F43, F44, F5 Function region

F19 Non-function region

1. An information processing device comprising:
an antenna that carries out short-range wireless communication with an information communication terminal; and
a position sensor that detects a position of the information communication terminal, on a position detection surface superposed on the antenna,
wherein at least one of at least one communicable region, of the antenna, where communication with the information communication terminal is possible is divided into a plurality of regions,
(1) the plurality of regions include a function region that is associated with a prescribed function, and a non-function region that is not associated with the prescribed function, or
(2) the plurality of regions include a plurality of types of function regions that are associated with mutually different functions, and
there is further provided a processing deciding unit that decides content of transmission or reception processing of information between the information communication terminal and the antenna in accordance with which region from among the plurality of regions includes the position of the information communication terminal detected by the position sensor.

2. The information processing device according to claim 1,
wherein there is further provided a target object determination unit that determines whether or not a target object that has come into contact with or approached the position detection surface is the information communication terminal, and
the processing deciding unit, in a case where the target object determination unit has determined that the target object is the information communication terminal, decides the content of the transmission or reception processing.

3. The information processing device according to claim 1,
wherein the position sensor is a touch panel that has the position detection surface.

4. The information processing device according to claim 1,
wherein there is further provided a display unit that is superposed on the position detection surface and displays the function region in at least one of the regions.

5. The information processing device according to claim 1, wherein the antenna is provided in plurality.

6. A method for controlling an information processing device comprising:
an antenna that carries out short-range wireless communication with an information communication terminal; and
a position sensor that detects a position of the information communication terminal, on a position detection surface superposed on the antenna,
wherein at least one of at least one communicable region, of the antenna, where communication with the information communication terminal is possible is divided into a plurality of regions,
(1) the plurality of regions include a function region that is associated with a prescribed function, and a non-function region that is not associated with the prescribed function, or
(2) the plurality of regions include a plurality of types of function regions that are associated with mutually different functions, and
the method includes a processing deciding step in which content of transmission or reception processing of information between the information communication terminal and the antenna is decided in accordance with which region from among the plurality of regions includes the position of the information communication terminal detected by the position sensor.
